(19) United States
(12) Patent Application Publication
(10) Pub. No.: US 2024/0369358 A1
(43) Pub. Date: Nov. 7, 2024

(54) PORTABLE OBJECT, IN PARTICULAR A WATCH, PROVIDED WITH A DEVICE FOR DETECTING THE CROSSING OF THE KÁRMÁN LINE, AND DETECTION METHOD

(71) Applicant: ETA SA MANUFACTURE HORLOGÈRE SUISSE, Grenchen (CH)

(72) Inventors: Laurent CHRISTE, Bienne (CH); Andréa DARDANELLI, Neuchâtel (CH); Gérard SURMELY, Villars-Epeney (CH); Fabian DUBOIS, Le Locle (CH); Jean-Luc BOVET, Solothurn (CH)

(73) Assignee: ETA SA MANUFACTURE HORLOGÈRE SUISSE, Grenchen (CH)

(21) Appl. No.: 18/597,345

(22) Filed: Mar. 6, 2024

(30) Foreign Application Priority Data
May 3, 2023 (EP) 23171366.0

(51) Int. Cl. G01C 5/00; G01C 21/16; G04B 47/06; G04G 9/00

(52) U.S. Cl. CPC G01C 5/00; G01C 21/166; G01C 21/188; G04B 47/061; G04G 9/0064

(57) ABSTRACT

A watch (2) including a memory (4) and a detection device (6), which device includes an acceleration sensor (8) for measuring an acceleration vector of the watch in a three-dimensional coordinate frame linked to the watch, and an electronic unit (12) that processes measurements supplied by the acceleration sensor. The electronic unit (12) detects, in association with the memory, at least for a rocket of a given type, crossing of the Kármán line by the rocket, solely by means of the watch on board the rocket. Crossing of the Kármán line by the watch is detected by detection device based on periodic measurements carried out by the acceleration sensor from rocket take-off until the crossing of the Kármán line, as defined before the space flight, and based on a corresponding reference value stored in the memory. The Kármán line is defined by a given altitude or a selectable altitude.

### CROSS REFERENCE TO RELATED APPLICATION

This application claims priority to European Patent Application No. 23171366.0 filed May 3, 2023, the entire contents of which are incorporated herein by reference.

### TECHNICAL FIELD OF THE INVENTION

The invention relates to a portable object, in particular a watch with a space application, for astronauts or other individuals travelling in space by means of a rocket or space shuttle. More specifically, the invention relates to a portable object, in particular a watch, provided with a device for detecting the crossing of the Kármán line, and to a method for detection the crossing of the Kármán line. The Kármán line defines the conventional boundary between the Earth's atmosphere and space. It is typically agreed that it corresponds to an altitude of 100 km; however, this altitude varies according to various organisations, in particular between 85 km and 110 km. The Kármán line is also the boundary where, in order to maintain flight, a spacecraft must fly at substantially an orbital velocity that allows it to maintain its orbit around the Earth.

### TECHNOLOGICAL BACKGROUND

Various watches have been worn by astronauts on space missions. Some watches worn by astronauts have been selected for their robustness and precision, without having any functions specific to a flight or mission in space. Other watches, particularly of the electronic type, offer specific functions useful for missions in space. These specific functions typically relate to the measurement of time, for example for a countdown and/or alarms.

### SUMMARY OF THE INVENTION

The purpose of this invention is to provide a portable object, in particular a watch, capable of detecting with sufficient accuracy the crossing of the Kármán line by a rocket or space shuttle (hereinafter referred to as a whole by the term ‘rocket’), at least for a given type of rocket (also referred to as a type of launch vehicle in the technical field of space flight), carrying this watch.

In particular, one objective of the present invention is to provide a portable object, in particular a watch, which allows a crossing of the Kármán line to be detected in an autonomous manner during a space flight, in particular without receiving external communication signals and thus without using a global positioning system (without ‘GPS’) and without receiving signals from the rocket relating to the real-time data of the concerned space flight during which it is intended to detect the crossing of the Kármán line by the rocket by means of the portable object on board this rocket.

Another objective of the present invention is to provide a portable object, in particular a watch, capable of detecting, with satisfactory accuracy, a crossing of the Kármán line by this portable object, which comprises relatively limited but accurate and space-saving technical means which can be easily incorporated into a portable object and in particular into a watch.

The present invention relates to a portable object that can be worn by a user, which portable object comprises a memory, a time base and a detection device formed by an acceleration sensor, capable of measuring an acceleration of the portable object along three orthogonal axes defining a coordinate frame linked to the portable object (i.e. capable of measuring an acceleration vector of the portable object in a three-dimensional coordinate frame of this portable object), and by an electronic unit arranged so as to be able to process measurements supplied by the acceleration sensor. The detection device is arranged, in association with the memory, to be able to autonomously detect, during a space flight of a rocket of a given type, a crossing of the Kármán line by the portable object on board this rocket, the Kármán line L_{K} being defined by a given altitude H_{D} or an altitude H_{S} that can be selected by a user, either directly or via another selectable spatial variable. The electronic unit can detect whether the rocket has crossed the Kármán line on the basis of periodic measurements of the acceleration vector of the portable object, taken by the acceleration sensor from rocket take-off until the Kármán line is crossed, and on the basis of either a predetermined reference value stored in the memory prior to said take-off, or a reference value calculated in the electronic unit and determined by a predetermined correction factor F_{C} stored in the memory prior to said take-off, and an altitude H_{S} selected by the user for the Kármán line L_{K} prior to said take-off. The predetermined reference value and the correction factor F_{C} relate to the given altitude H_{D}. The electronic unit is arranged such that it can calculate the changes to a comparison distance over time on the basis of the periodic measurements of the acceleration vector of the portable object, and such that it can compare this comparison distance over time with the predetermined reference value, respectively with the calculated reference value, so as to be able to detect a crossing of the Kármán line by the portable object and thus by the rocket.

Thus the portable object according to the invention is noteworthy in that it is designed to be able to autonomously detect the crossing of the Kármán line by this portable object on board a rocket of a given type, with, as the only technical means required, a memory and a detection device comprising an acceleration sensor, capable of measuring the components of an acceleration vector relative to the portable object in a coordinate frame linked to this portable object, and an electronic unit for processing the measurements supplied by the acceleration sensor. The portable object according to the invention thus does not require a three-axis gyrometer, which can certainly be miniature, formed by a microelectromechanical system (also known by the acronym ‘MEMS’), but which is typically not very accurate, and in any case not sufficiently accurate to allow for precise detection of changes in the orientation of a coordinate frame specific to said acceleration sensor during space flight, so as to be able to determine the vertical component of the acceleration of the rocket's motion at any time between take-off and the crossing of the Kármán line, and thus allow its altitude to be determined over time. The invention thus avoids the problem associated with small gyrometers, which are relatively inaccurate and thus unable to provide sufficiently accurate measurements of the angular velocity of the portable object to determine its instantaneous orientation and changes in its position in space, in particular its altitude, whereas a relatively inexpensive acceleration sensor of small dimensions, of the same order of magnitude, can provide accurate acceleration measurements along three axes.

In a main embodiment, the portable object is a watch.

In a preferred embodiment, the acceleration sensor is a microelectromechanical system (also known by the acronym ‘MEMS’). Such a sensor is small, so that it can easily be incorporated into a watch. It should be noted that, despite its small size, such an acceleration sensor can be very accurate. By selecting such an acceleration sensor, said predetermined reference value is also advantageously defined on the basis of a nominal acceleration of motion for the rocket. The term ‘acceleration of motion’ is understood to mean an acceleration corresponding to the time derivative of the velocity, this acceleration of motion defining, at all times, a vector tangent to the trajectory of the rocket, and thus of the portable object, in space, i.e. a vector collinear with the instantaneous direction vector of the rocket. The term ‘nominal’ is understood to mean a value given in the specification for the type of rocket in question or for a certain rocket; it is thus a theoretical value, in this case dependent on time, predicted for the rocket in question and which results from its design and from the planning of a space flight with such a rocket, in particular from its launch until it crosses the Kármán line in the context of the present invention. It should be noted, however, that a MEMS-type accelerometer does not provide an acceleration of motion, but rather a proper acceleration which, in the absence of sufficiently precise data on the instantaneous orientation of the rocket in space, does not make it possible to determine the acceleration of motion and, in particular, the vertical component of such an acceleration, which is primarily considered when determining the instantaneous altitude of the rocket. The present invention provides a noteworthy solution to this problem, as will become clear from the detailed description hereinbelow.

In a preferred alternative embodiment, the detection device is arranged so that said comparison distance is calculated on the basis of the norms of the acceleration vectors measured by the acceleration sensor and whose components are given in said coordinate frame linked to the portable object, the electronic unit being arranged such that it can calculate these norms. More specifically, the acceleration sensor provides acceleration vectors in a proper coordinate frame, yet the norm of the acceleration vector is independent of the coordinate frame, i.e. it is invariable, regardless of the spatial orientation of the coordinate frame in which this acceleration vector is given, so that an indeterminacy of the orientation of the measurement coordinate frame for the acceleration measurements is no longer problematic. This preferred alternative embodiment is highly advantageous because it overcomes the fact that a coordinate frame linked to the portable object, i.e. the coordinate frame defined by the acceleration sensor which is fixed relative to the portable object, has an orientation, relative to a terrestrial coordinate frame, which is variable during a space flight between the rocket launch base and the Kármán line, in particular because the rocket does not follow a vertical linear trajectory. Moreover, the orientation of the portable object can vary over time relative to the rocket, as a result of the movements of the user wearing it.

According to an advantageous alternative embodiment, the correction factor is equal to said predetermined reference value divided by the given altitude.

According to a general embodiment, the predetermined reference value is defined on the basis of at least one theoretical function of a spatial variable relating to said rocket, from rocket take-off to the given altitude for the Kármán line.

In a general alternative embodiment, the portable object is arranged so that a record of the fact that the Kármán line has been exceeded is made in a protected part of its memory, so that a user of this portable object cannot write to the protected part.

The invention further relates to a method for detecting, according to the accompanying claim 1, by means of a portable object according to the invention, a crossing of the Kármán line by a rocket of a given type carrying this portable object. Alternative embodiments are given in the claims dependent on this claim 1.

### BRIEF DESCRIPTION OF THE FIGURES

The invention will be described in more detail hereinafter with reference to the accompanying drawings, given by way of examples that are in no way limiting, in which:

FIG. 1 diagrammatically shows a watch according to the invention with various electronic parts forming this watch;

FIG. 2 shows a trajectory, which trajectory is interrupted in the drawing, that is taken by a rocket during a flight in space, between take-off and the crossing of the Kármán line, as well as various variables relating to the flight along this trajectory and involved in a method for detecting crossing of the Kármán line according to the invention and the implementation thereof in a device for detecting crossing of the Kármán line according to a main embodiment of the invention;

FIG. 3 shows an enlarged view, relative to FIG. 2, of a vector sum of various accelerations involved in the method for detecting crossing of the Kármán line according to the invention, the orthogonal axes Xₜ and Zₜ being parallel to the X and Z axes of FIG. 2 and having their origin at the point P_{S}(t) on the trajectory T_{F}(x) of the rocket concerned, this point P_{S}(t) defining an altitude H_{F}(t) and a horizontal distance E_{H}(t) for the rocket over time;

FIG. 4 shows a theoretical curve of the acceleration of movement of a rocket of a certain type as a function of time;

FIG. 5 shows a curve giving the tilt angle of said rocket over time, as measured during a flight of the rocket, and a theoretical curve for this tilt angle;

FIG. 6 shows a curve giving the theoretical altitude of said rocket over time;

FIG. 7A to 7D show various messages given by the watch, according to an alternative embodiment, to a user during a flight in space and a detection of the crossing of the Kármán line by the watch according to the invention implementing the detection method according to the invention; and

FIGS. 8A and 8B show two messages that can be displayed by the watch, according to an alternative embodiment, to a user of the watch after this watch has detected crossing of the Kármán line and more particularly after a completed space flight or mission.

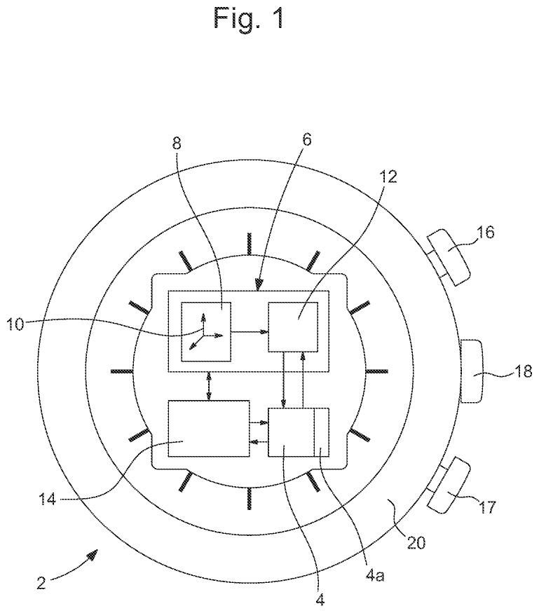

### DETAILED DESCRIPTION OF THE INVENTION

Embodiments of a portable object according to the invention will be described hereinbelow with reference to the drawings, which portable object consists of a watch, as well as a method for detecting the crossing of the Kármán line by such a portable object according to a main embodiment of the invention.

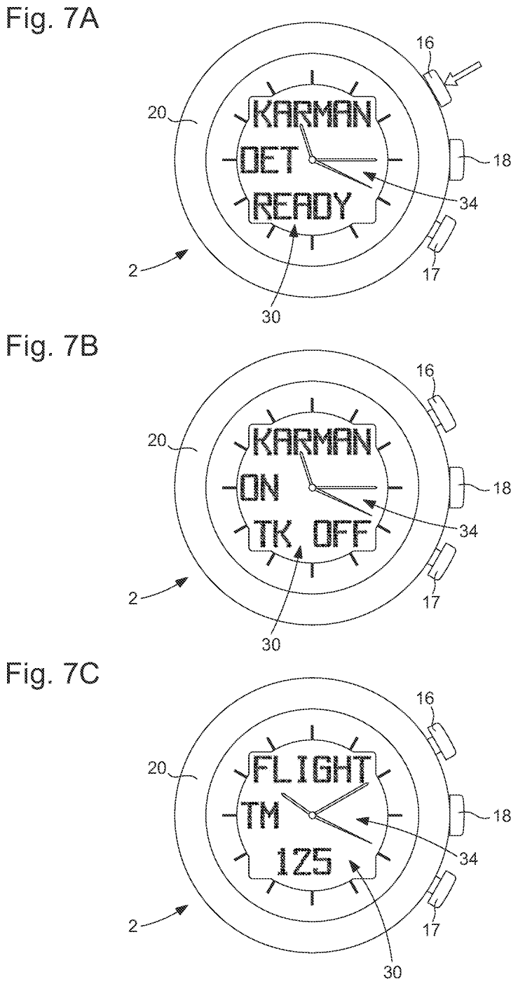

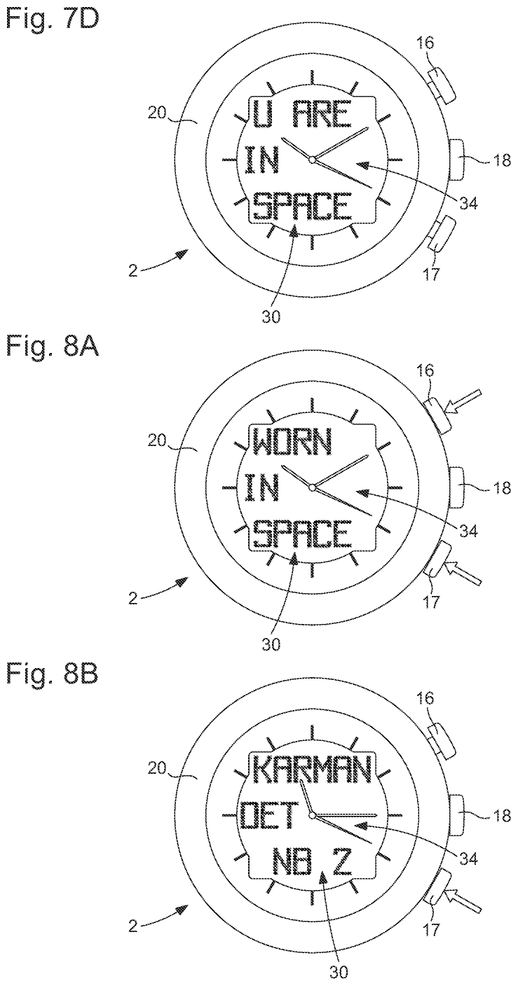

According to a general embodiment, the watch 2 comprises a memory 4 and a detection device 6, which device comprises an acceleration sensor 8 capable of measuring an acceleration vector of the watch in a three-dimensional coordinate frame 10 linked to the watch 2, and an electronic processing unit 12, hereinafter also referred to as the ‘electronic unit’, which is arranged such that it can process measurements supplied by the acceleration sensor 8. The watch further comprises an electronic control unit 14, which is in particular arranged such that it can activate the detection device 6 in response to actuation of an external control member. This watch is equipped with various external control members, in particular two push-buttons 16 and 17 and a stem-crown 18. It should be noted that the watch can be equipped with tactile control means, in particular a tactile crystal covering the display means, such tactile control means being provided, for example, for data input into the watch memory 4 and/or for controlling the display of certain data by the display means, in particular before and after a space flight or a space mission. In a particular alternative embodiment shown in FIG. 7A, the watch comprises an analogue display 34, formed by hands associated with a graduation, and a digital display 30 formed by an electronic display module defining a major part of the dial of the watch 2. It should be noted that the hands can be used conventionally to indicate time data, but also to indicate other things, for example to indicate a current step in the detection method or an event such as the crossing of the Kármán line, or to indicate the correct progression of an operation prior to a flight or its completion.

The electronic unit 12 is arranged, in association with the acceleration sensor 8 and the memory 4, such that it can detect, at least for a rocket of a given type, crossing of the Kármán line L_{K} by the rocket, solely by means of the watch 2 on board this rocket. Detection is thus carried out autonomously by the watch during the rocket's space flight by way of the watch's detection device. The Kármán line L_{K} is defined by a given altitude H_{D} or by a user-selectable altitude H_{S}, either directly or via the selection of another spatial variable. The term ‘given altitude’ is understood to mean an altitude that has been predefined/predetermined by the manufacturer of the watch or by an authorised person or company, and not by a user. In the case of a plurality of given altitudes, however, it is possible for these to be selectable by a user, i.e. the user can select a given altitude from the plurality of given altitudes.

Crossing of the Kármán line L_{K} by the rocket 22 carrying the watch 2 can be detected by the detection device 6 on the basis of periodic measurements of the acceleration vector of this watch, taken by the acceleration sensor 8 from rocket take-off until the crossing of the Kármán line, and a reference value corresponding to an altitude defined for this Kármán line, this reference value being recorded in the memory 4 of the watch prior to a space flight during which the crossing of said altitude defined for the Kármán line by the rocket is intended to be detected by means of the watch on board this rocket. Alternative embodiments for defining and calculating this reference value will be given hereinbelow. The watch comprises a time base allowing periods for taking the periodic measurements of the acceleration vector to be successively determined. More generally, in the case of a portable object, this portable object comprises a time base arranged to be able to determine successive periods and thus allow the detection device to carry out periodic measurements of the acceleration vector. In an alternative embodiment, the time base can be a unit separate from the detection device and associated therewith, in particular to allow for periodic activation of the acceleration sensor. In another alternative embodiment, the time base is incorporated into the detection device. In a particular alternative embodiment, this time base is directly associated with the acceleration sensor so as to be able to clock the measurements of the acceleration vector.

More specifically, the reference value is either a predetermined reference value previously stored in the memory, or a reference value calculated in the electronic unit and determined by a correction factor F_{C}, predetermined and previously stored in the memory 4, and an altitude H_{S} selected for the Kármán line L_{K} by the user. The predetermined reference value and the correction factor are relative to the given altitude H_{D}. The electronic unit 12 is arranged such that it can calculate the changes to a comparison distance over time on the basis of the periodic measurements of the acceleration of the rocket, and such that it can compare this comparison distance over time with the predetermined reference value, respectively with the calculated reference value, so as to be able to detect a crossing of the Kármán line by the watch 2 and thus by the rocket 22. The reference value is advantageously recorded in the memory 4 when the watch is programmed ‘at the factory’ or subsequently by means of a specific device configured to supply the watch with this reference value. In a simpler alternative embodiment, the watch can be arranged to allow the reference value to be entered into the watch, i.e. into its memory 4, via the control members with which the watch is equipped.

According to an advantageous alternative embodiment, the correction factor F_{C} is equal to said predetermined reference value divided by said given altitude H_{D}.

According to a preferred alternative embodiment, the predetermined reference value is defined on the basis of at least one theoretical function of a spatial variable relating to said rocket, from rocket take-off to the given altitude H_{D} for the Kármán line L_{K}.

In a first particular embodiment, the memory 4 is arranged to contain a plurality of predetermined reference values which respectively relate to a plurality of given altitudes H_{Dj}, j=1 to J. Each of the predetermined reference values is defined, in general terms, on the basis of at least one theoretical function of a spatial variable relating to the rocket concerned, from a rocket take-off up to the corresponding given altitude, each of the given altitudes H_{Dj} being selectable, by a user, to allow said comparison distance over time, calculated when the watch detects the crossing of the Kármán line, to be compared with the corresponding predetermined reference value.

In a second particular embodiment, the memory 4 is arranged to contain a plurality of correction factors F_{Cj}, j=1 to J, respectively relating to a plurality of given altitudes H_{Dj}, j=1 to J. Each of the correction factors F_{Cj} can be selected automatically by the detection device or optionally by a user, as a function of an altitude H_{S} selected by this user for the Kármán line L_{K}, to allow said comparison distance over time, calculated when the watch detects the crossing of the Kármán line, to be compared with a reference value determined by the selected correction factor and the selected altitude H_{S}.

In an advantageous alternative embodiment of the second particular embodiment, a plurality of predetermined reference values are respectively defined for the plurality of given altitudes H_{Dj}, each of the predetermined reference values being defined, in a general manner, on the basis of at least one theoretical function of a spatial variable relating to the rocket concerned, from rocket take-off to the corresponding given altitude. The plurality of correction factors F_{Cj} are respectively equal to the plurality of predetermined reference values respectively divided by the plurality of given altitudes H_{Dj}. Each correction factor makes it possible to obtain, by multiplication with a selectable and thus variable altitude H_{S} for the Kármán line, a reference value to allow a comparison to be made, in the electronic unit of the watch, with a comparison distance supplied by the detection device during a space flight of the rocket concerned and thus allowing the crossing of the Kármán line by the watch and thus by the rocket to be detected

According to a preferred embodiment, the acceleration sensor 8 is formed by a microelectromechanical system (MEMS).

According to a preferred embodiment, in the event that only one predetermined reference value is provided, this predetermined reference value is also defined on the basis of a nominal acceleration of motion for the rocket. In the event that a plurality of reference values are provided, each predetermined reference value is also defined on the basis of a nominal acceleration of motion for the rocket, from rocket take-off to the given altitude H_{D} for the Kármán line.

A method for detecting the crossing of the Kármán line by a rocket using a watch according to the invention will be described below. The following description makes it easier to explain how various variables and functions are defined and/or obtained and exactly how they are involved in the context of the invention. This detection method can be implemented by a watch according to a main embodiment which will be described below.

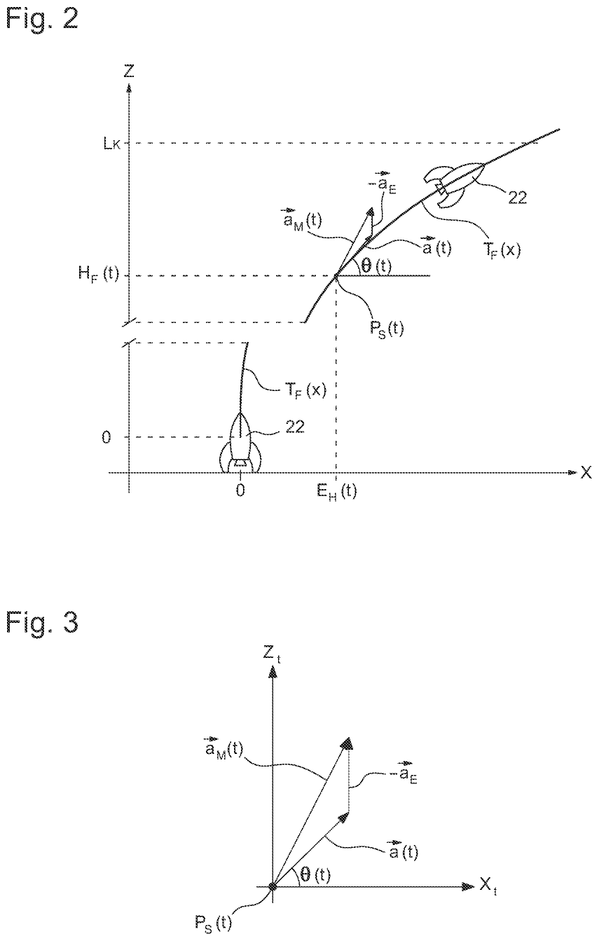

The invention relates to a detection method for detecting the crossing of the Kármán line L_{K}, defined by a given altitude H_{D} or by a selected altitude H_{S}, by a rocket 22 of a given type, during a space flight of this rocket, which detection is made by a portable object capable of being worn by a user, in particular a watch 2 on board this rocket and comprising a memory 4, a time base and a detection device 6, which is formed by an acceleration sensor 8, arranged to measure a proper acceleration vector a_{M}* of the watch in a three-dimensional coordinate frame 10 linked to this watch, and by an electronic unit 12 arranged to be able to process measurements supplied by the acceleration sensor, the proper acceleration vector a_{M}* being equal, in a first approximation for a rocket, to an acceleration of motion vector a* of this watch minus the gravitational acceleration vector a_{E}* at any instant/at any time t. It should be noted that the asterisk (*) is used in this text to indicate a vector, whereas in FIGS. 2 and 3, the vectors are indicated in the conventional manner by arrows located above the variables concerned. In general, the proper acceleration vector of the watch is equal to a vector sum of the forces experienced by the watch, except for the force of gravity, divided by its mass. In other words, the proper acceleration of an object is the acceleration that this object undergoes for an observer in free fall.

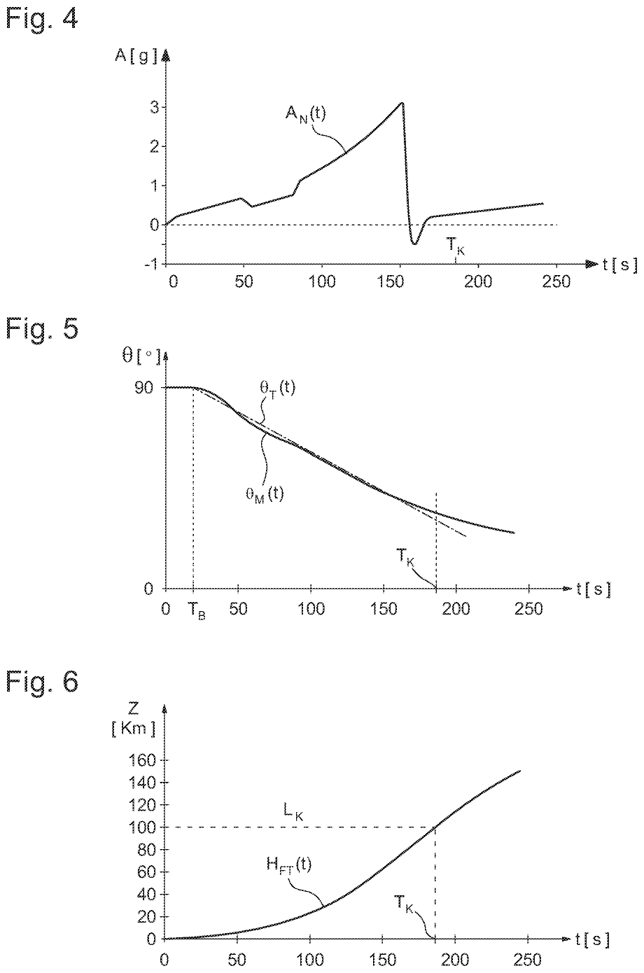

The detection method comprises a preliminary phase, which is preliminary to the portable object being placed on board the rocket for the planned space flight, comprising the following preliminary steps of:
A) Providing a nominal acceleration of motion A_{N}(t) for the rocket 22, as a function of time t, from rocket take-off, defining a time zero, at least up to a crossing of the given altitude H_{D} for the Kármán line L_{K}, this nominal acceleration of motion being a scalar value (norm of a nominal acceleration of motion vector) in a unit equal to the gravitational pull of the Earth (this dimensionless scalar value thus corresponding to the norm of the nominal acceleration of motion vector divided by the norm of the gravitation pull of the Earth, see FIG. 4).
B) Providing a theoretical tilt angle θ_{T}(t) for the rocket of the given type, relative to a horizontal plane and as a function of time t, from rocket take-off until at least one crossing of the given altitude H_{D} (see FIG. 5).
C) Providing or determining a theoretical time of flight T_{K} for the rocket of the given type from rocket take-off to the crossing of the given altitude H_{D}.
D) On the basis of said nominal acceleration of motion and of said theoretical tilt angle, determining a theoretical proper acceleration A_{PT} (t), as a function of time, for the rocket of the given type, the value of this theoretical proper acceleration being defined, in a unit equal to the gravitational pull of the Earth, by the following formula:

$${A}_{PT} ( t ) = \sqrt{1 + 2 \cdot {A}_{N} ( t ) \cdot sin {θ}_{T} ( t ) + {{A}_{N}}^{2} ( t )}$$

E) Calculating, by numerical and/or mathematical means, a theoretical measurement distance D_{MT} defined by a double integral of the theoretical proper acceleration A_{PT} (t), between time zero (t=0) corresponding to rocket take-off and time TK corresponding to the theoretical time of flight, or of this theoretical proper acceleration less the norm of the gravitational acceleration; the theoretical measurement distance D_{MT} divided by the given altitude H_{D} for the Kármán line L_{K} defining, for the rocket of the given type, a correction factor F_{C}.
F) Recording the theoretical measurement distance D_{MT} and/or the correction factor F_{C} in the watch memory, this correction factor F_{C} then being, where applicable, multiplied by the selected altitude H_{S}, before rocket take-off defining a start of said space flight, so as to obtain a reference distance D_{MR}.
G) Before rocket take-off, activating the detection device of the watch on board this rocket.

The detection method then comprises a detection phase comprising the following detection steps of:
H) Periodically measuring, at a measurement frequency F_{M}, the proper acceleration vector of the watch, in the three-dimensional coordinate frame of this watch, by means of said detection device, and calculating in the electronic unit, for each measurement, the norm A_{M} (tₙ) of the measured proper acceleration vector, respectively a corrected norm equal to the norm A_{M}(tₙ) less the norm of the gravitational acceleration, tₙ being a time equal to n·P where n is a number of measurements carried out at least since rocket take-off, incremented by one unit with each new measurement, and P is the time period defined by the measurement frequency.
I) Calculating numerically, in the electronic unit, a double integral over time, from rocket take-off, respectively at least from rocket take-off, of the norm of the proper acceleration vector of the watch, respectively of this norm less the norm of the gravitational acceleration, the norm of the proper acceleration vector being determined on the basis of said norms A_{M}(tₙ) of the proper acceleration vector measured periodically, in order to obtain comparison distances D_{C}(tₘ) for times tₘ, where m is a positive integer, each m corresponding to one said number n.
J) Comparing each comparison distance D_{C}(tₘ) with the theoretical measurement distance D_{MT} in the case of a given altitude H_{D} or with the reference distance D_{MR} in the case of a selected altitude H_{S} and, when a comparison distance D_{C}(tₘ) is greater than the theoretical measurement distance D_{MT}, or respectively the reference distance D_{MR}, recording, in the memory of the portable object, a detection, by the detection device, of the crossing of the Kármán line by this portable object.

In a preferred alternative embodiment of the detection method, the acceleration sensor used to measure the proper acceleration vector of the watch, and thus normally of the rocket, is a microelectromechanical system (MEMS) incorporated into this watch.

With regard to step A), FIG. 4 shows an example for the curve of the nominal acceleration of motion A_{N} (t), for a certain rocket, from rocket take-off to beyond the Kármán line defined by the given altitude H_{D}. It should be noted that supplying the acceleration A_{N} (t) can consist in supplying at least a plurality of predefined values of this acceleration A_{N} (t) for a plurality of successive times, in particular periodic times, from take-off at least until crossing the given altitude. It should also be noted that the theoretical acceleration of motion A_{N} (t) can momentarily be negative, i.e. the velocity of the rocket can momentarily decrease, as shown in the graph in FIG. 4. Thus, the nominal acceleration of motion is provided with its mathematical sign and must be entered with this mathematical sign in the formula given in step D).

In an alternative embodiment, the acceleration A_{N} (t) is provided by supplying the theoretical distance travelled L_{FT} (t) by the rocket over time, at least for a plurality of successive times, in particular periodic times, from take-off at least until crossing the given altitude H_{D}. The acceleration A_{N} (t) is then determined, mathematically and/or numerically, from the theoretical distance L_{FT} (t) travelled by the rocket as a function of time, via a double derivative of this theoretical distance. In another alternative embodiment, the acceleration A_{N} (t) is provided by supplying the theoretical altitude H_{FT} (t) of the rocket over time, at least for a plurality of successive times, in particular periodic times, and a theoretical trajectory z=T_{FT} (x) of the rocket in space, from its point of departure at least until crossing the given altitude (for the sake of simplicity, in a vertical plane X-Z, z being a variable corresponding to the altitude and x being a variable corresponding to a horizontal distance from the rocket's point of departure). The nominal acceleration of motion A_{N}(t) is then determined, mathematically and/or numerically, from the theoretical altitude H_{FT} (t) of the rocket and the theoretical trajectory T_{FT} (x) followed by this rocket in space, these two functions making it possible to obtain the theoretical distance L_{FT} (t) mentioned above.

With regard to step B) of the detection method, FIG. 5 shows an example for the curve of the theoretical tilt angle θ_{T} (t) of the rocket concerned as a function of time. FIG. 5 further shows a curve θ_{M} (t) of a tilt angle measured over time during a space flight of a rocket of a certain type. It shows that a linear approximation, from a time T_{B} at which the rocket begins to tilt, is relatively accurate here. Until time T_{B}, the rocket follows a vertical direction such that the theoretical tilt angle θ_{T} (t) is 90° between time zero and time T_{B}. It should be noted that supplying the theoretical tilt angle θ_{T} (t) can consist in supplying at least a plurality of predefined values of this theoretical tilt angle θ_{T} (t) for a plurality of successive times, in particular periodic times, from rocket take-off at least until crossing the given altitude.

FIG. 2 shows an example of a trajectory z=T_{F} (x) of the rocket 22 (which trajectory is interrupted in this figure for reasons of scale). It should be noted that the examples given in the figures in no way limit the theoretical curves that can be envisaged, which are typically specific to each type of rocket (type of launch vehicle in particular for a space shuttle). The tilt angle θ(t), at a time t, between the direction of the rocket at time t and a horizontal plane is defined by the tangent to the trajectory z=T_{F} (x) of the rocket at its spatial position P_{S}(t), the variable x being a function of time. Thus, the tangent function of the angle θ(t) is equal to the derivative of the trajectory T_{F} (x) relative to the horizontal distance x to the rocket's spatial position P_{S}(t). This gives the mathematical relationship tan θ(t)=dT_{F} (x)/dx where x=E_{H} (t), and E_{H} (t) being the horizontal distance of the rocket from the point of departure as a function of time. Similarly, where T_{FT} (x) is the theoretical trajectory of the rocket of the given type and θ_{T} (t) is the theoretical tilt angle of this rocket at time t, the theoretical tilt angle θ_{T} (t) can be determined, by mathematical and/or numerical means, by the theoretical trajectory z=T_{FT} (x) via the aforementioned mathematical relationship tan θ_{T}(t)=dT_{FT} (x)/dx where X=E_{HT} (t), and E_{HT} (t) being the theoretical horizontal distance of the rocket from a point of departure as a function of time. It should be noted that the function E_{HT} (t) can be determined, mathematically and/or numerically, on the basis of the theoretical trajectory T_{FT} (x) and the nominal acceleration of motion A_{N}(t) or the theoretical altitude H_{FT} (t) of the rocket as a function of time. Thus, in an alternative embodiment, the theoretical tilt angle θ_{T} (t) is provided in step B) of the detection method by supplying the theoretical trajectory T_{FT} (x) of the rocket in space and the theoretical horizontal distance E_{HT} (t) of this rocket, this theoretical horizontal distance E_{HT} (t) being able in particular to be determined mathematically and/or numerically on the basis of the nominal acceleration of motion A_{N} (t) and of the theoretical trajectory Z=T_{FT} (x) or alternatively of this theoretical trajectory and of the theoretical altitude H_{FT} (t) of the rocket as a function of time.

With regard to step C) relating to the theoretical time of flight T_{K}, it is possible, in a simplified alternative embodiment, to estimate this theoretical time of flight on the basis of at least one previous space flight with a rocket of the type concerned. In an advantageous alternative embodiment which does not require previous flights, the theoretical time of flight T_{K} is to be determined by mathematical and numerical means on the basis of the nominal acceleration of motion A_{N}(t) and the theoretical tilt angle θ_{T}(t) of the rocket. To this end, the following approach can be taken by defining a theoretical distance L_{T}(t) travelled by the rocket as a function of time. A mathematical relationship can be established between the theoretical altitude H_{FT}(t) of the rocket in flight and the theoretical distance L_{T}(t) travelled by this rocket. An infinitesimal/elementary variation in the theoretical altitude dH_{FT}(t)=dL_{T}(t)·sin θ_{T}(t) where dH_{FT}(t) is an infinitesimal/elementary variation in the theoretical distance travelled. On the other hand, the variation dL_{T}(t)=V_{N}(t)·dt where V_{N}(t) is the nominal velocity of the rocket at time t and dt is an infinitesimal/elementary variation in time. The nominal velocity V_{N}(t) can be determined mathematically and/or numerically on the basis of the nominal acceleration of motion A_{N}(t), given that the velocity is equal to the integral of acceleration over time. We can thus define the infinitesimal/elementary variation dH_{FT}(t) of the theoretical altitude H_{FT}(t), on the basis of the mathematical relationships given above, as a function of given (nominal/theoretical) variables. This gives:

$${dH}_{FT} ( t ) = {V}_{N} ( t ) \cdot sin {θ}_{T} ( t ) \cdot dt , \\ where {V}_{N} ( t ) = {\int }_{0}^{t} {A}_{N} ( t ) \cdot dt$$

The theoretical altitude H_{FT}(t) is equal to the integral over time of dH_{FT}(t) calculated by mathematical and/or numerical means. To determine the theoretical time of flight T_{K}, the equation H_{FT} (T)=H_{D} is solved, where H_{D} is the given altitude and T is the variable.

FIG. 6 shows an example for the curve of theoretical altitude H_{FT}(t) as a function of time on the basis of the nominal acceleration of motion A_{N}(t) curve given in FIG. 4 and of the theoretical tilt angle θ_{T}(t) curve given in FIG. 5.

Steps D) and E) of the detection method are characterised in that they are designed to allow a theoretical measurement distance D_{MT} corresponding to a predetermined reference value to be accurately determined, against which a comparison distance subsequently accurately calculated in the electronic unit of the watch can be compared, according to a main embodiment of the invention, on the basis of the proper acceleration measurements supplied by the acceleration sensor arranged in the watch, during a space flight with a rocket carrying this watch. In this main embodiment of the watch, the autonomous detection device is considered to use as its measurement means only an acceleration sensor arranged to be able to measure vectors of the proper acceleration experienced by the watch. The method involves determining beforehand, i.e. in a preliminary step prior to the space flight in question, a theoretical measurement distance D_{MT} which is a fictitious theoretical distance in that it does not correspond to a distance theoretically travelled by the rocket between the ground and the Kármán line, but rather to a theoretical distance resulting from the fact that the watch's proper acceleration is being measured. Moreover, given the limited means of measurement, a reference value will be supplied, which value depends only on the norm of the proper acceleration, the vector whereof in a coordinate frame of the watch 2 is supplied by the acceleration sensor, advantageously corrected by the norm of the gravitational acceleration by subtracting it from the norm of the proper acceleration, and on the trajectory of the rocket. A crossing of the Kármán line is thus intended to be defined on the basis of the norm of the proper acceleration of the watch and thus normally of the rocket carrying it, this norm being independent of the spatial orientation of the acceleration sensor coordinate frame, as already indicated.

The detection method takes into account the fact that the norm of the proper acceleration vector, for a given acceleration of motion, varies according to the tilt of the rocket. In fact, this norm, less the norm of the gravitational acceleration, does not give the acceleration of motion of the watch/rocket when the rocket does not have a vertical direction. FIGS. 2 and 3 show, for a rocket, the vector relationship between the acceleration of motion a*, the measured proper acceleration a_{M}* and the gravitational acceleration a_{E}*. An acceleration of motion vector a(t)* and a measured proper acceleration vector a_{M}(t)* correspond to the spatial position P_{S}(t) of the rocket at the time t of a space flight, the gravitational acceleration vector a_{E}* always being vertical and independent of the spatial position of the rocket. It should be noted that the small centripetal acceleration experienced by the rocket as it gradually tilts is not taken into account in the relationship between the rocket's proper acceleration, which includes such a centripetal acceleration, and the rocket's acceleration of motion, as this centripetal acceleration is small and insignificant for a rocket between the ground and the Kármán line. The detection method provides for calculating, in a step preliminary to the space flight, namely in step D), a theoretical proper acceleration A_{PT}(t) of the rocket over the time t as a function of the nominal acceleration of motion A_{N}(t) and the theoretical tilt angle θ_{T}(t) of the rocket supplied respectively in steps A) and B). Then, in step E), the theoretical measurement distance D_{MT} is calculated by a double integral of the theoretical proper acceleration A_{PT}(t), between time zero (t=0) corresponding to rocket take-off and time T_{K} corresponding to the theoretical time of flight calculated in step C), or advantageously of this theoretical proper acceleration less the norm of the gravitational acceleration A_{E}.

It should be noted that, in the absence of any information indicating that we are talking about an acceleration vector, this descriptive text refers either to the value of the acceleration mentioned (length of the vector with the mathematical sign given as a function of the direction of motion, which in this description only relates to the acceleration of motion), or the norm of an acceleration vector (i.e. the absolute value of the length of the vector, as is the case for the rocket's proper acceleration and for gravitational acceleration). More specifically, when an acceleration is mentioned, this refers to the value of that acceleration, and when the norm of an acceleration is mentioned, this refers to the norm of the corresponding acceleration vector, i.e. the absolute value of the acceleration.

The theoretical measurement distance D_{MT} divided by the given altitude H_{D} for the Kármán line L_{K} defines, in the context of the detection method according to the invention, for the rocket of the given type, a correction factor F_{C}.

Step F) provides for storing, prior to a space flight, i.e. before rocket take-off, the theoretical measurement distance D_{MT} and/or the correction factor F_{C} in the watch's memory. The correction factor F_{C} is useful for obtaining a reference distance D_{MR} when it is expected that the user will be able to provide the watch with a selected altitude H_{S} for the Kármán line, the correction factor F_{C} being, in this case, multiplied by the selected altitude H_{S} for the Kármán line to calculate the reference distance D_{MR}. It should be noted that this reference distance D_{MR} is in fact an approximate theoretical distance, given the linear approximation which is made here from the theoretical measurement distance D_{MT}, which is determined precisely for the given altitude H_{D}.

Steps H) to J) of the detection method relate to the steps of detecting a crossing of the Kármán line during a space flight of a rocket of the given type by means of the portable object according to the invention, in particular a watch according to the main embodiment. Thus, the detection device 6 of the watch 2 periodically measures, at a measurement frequency F_{M}, the components of the proper acceleration vector of the watch, along the three orthogonal axes of the three-dimensional coordinate frame defined by the acceleration sensor, and then the electronic unit calculates, for each measurement, the norm A_{M}(tₙ) of this proper acceleration vector measured at each measurement time tₙ, or respectively a corrected norm equal to the norm A_{M}(tₙ) less the norm of the gravitational acceleration A_{E}, depending on whether or not the theoretical proper acceleration A_{PT}(t) has been reduced by the norm of the gravitational acceleration in the calculation of the theoretical measurement distance D_{MT} in step E). In order to be able to periodically carry out measurements of the acceleration vector of the watch, the latter comprises a time base arranged to allow successive determination of the periods corresponding to the planned measurement frequency and thus to allow the detection device to control the acceleration sensor so that it carries out the planned periodic measurements.

Subsequently, in accordance with the theoretical calculations made in the preceding preliminary steps, the electronic unit 12 numerically calculates a double integral over time, from rocket take-off, of the norm of the proper acceleration A_{P}(t) of the watch on board the rocket, respectively of this norm advantageously less the norm of the gravitational acceleration. The norm of the proper acceleration A_{P}(t) is determined, in general, on the basis of said norms A_{M}(tₙ) of the proper acceleration vectors measured periodically, in order to obtain comparison distances D_{C}(tₘ) for times tₘ, where m is a positive integer, each m corresponding to one said number n. In a preferred alternative embodiment, a comparison distance D_{C}(tₙ) is calculated for each measurement taking place at times tₙ. Finally, each comparison distance D_{C}(tₘ) is compared, preferably almost in real time, with the theoretical measurement distance D_{MT} in the case of a given altitude H_{D}, or respectively with the reference distance D_{MR} in the case of a selected altitude H_{S}. The comparison distances D_{C}(tₘ) are fictitious distances, like the theoretical measurement distance D_{MT} and the reference distance D_{MR}. When a comparison distance D_{C}(tₘ), for a time tₘ, is greater than the theoretical measurement distance D_{MT}, or respectively greater than the reference distance D_{MR}, the electronic unit of the detection device records in the memory of the watch the fact that the Kármán line L_{K} has been crossed by the watch and thus by the rocket. Rocket take-off can be easily detected on the basis of the norms A_{M}(tₙ) of the proper acceleration measured periodically and starting before take-off. In fact, as long as this norm is substantially equal to the norm of the gravitational acceleration, the electronic unit can conclude that the rocket has not yet taken off and determine a rocket take-off time, for example when the norm of the proper acceleration measured exceeds a certain given limit value. In the main advantageous alternative embodiment which uses the norm of the proper acceleration A_{P}(t) of the watch less the norm of the gravitational acceleration A_{E}, it should be noted that it is advantageously possible to start calculating the integral on this proper acceleration corrected by the gravitational attraction before rocket take-off, given that this value is theoretically null and in practice substantially equal to zero. The value of the integral will thus remain substantially equal to zero before rocket take-off. It should be noted that the measurements of the proper acceleration taken by the acceleration sensor are advantageously filtered so as to eliminate any parasitic noise.

In a particular implementation, the detection method is characterised in that the step of calculating the double integral over time in the electronic unit, in step I), consists of performing a double integral by increments by defining, after each measurement of the proper acceleration, a constant value A_{C}(tₙ) for the norm of the proper acceleration over each period P between the times tₙ₋₁ and tₙ of two successive measurements, this constant value being determined by the norm A_{M}(tₙ) and/or by the norm A_{M}(tₙ₋₁); of calculating, for each period P, an increase in velocity corresponding to said constant value, respectively to the constant value less the norm of the gravitational acceleration, in order then to determine an estimated velocity V_{E}(tₙ) at time tₙ, and an elementary distance dₙ on the basis of the constant value A_{C}(tₙ), or respectively on the basis of this constant value less the norm of the gravitational acceleration and the estimated velocity V_{E}(tₙ₋₁) at the time tₙ₋₁, and then adding the elementary distance dₙ to the sum of the elementary distances d₁ to dₙ₋₁, obtained at the end of the previous measurement of the proper acceleration, to obtain a comparison distance D_{C}(tₙ) for the time tₙ. It should be noted that the calculations provided in the electronic unit advantageously require relatively low computing power.

In an alternative embodiment in which provision is made for a user to be able to select a selected altitude H_{S} for the Kármán limit L_{K}, this selection is indirect, i.e. provision is made for the user to be able to select, via control members with which the watch is equipped, a tilt angle of the rocket which is provided for the crossing of the Kármán line by this rocket. Selection of the tilt angle can consist in entering any value on the basis of data for the space flight concerned or in selecting, from a list that can be displayed successively by the watch, a specific value from a plurality of proposed values. This selection, as in the case where a selected altitude H_{S} is directly supplied, is made before the space flight in question with the rocket of the given type. The selected altitude H_{S} is determined as a function of the selected tilt angle, the electronic unit 12 being arranged to be able to convert the tilt angle supplied into a corresponding selected altitude H_{S}.

According to an improved implementation, the detection method according to the invention is characterised in that the theoretical measurement distance D_{MT} is determined for each given altitude of a plurality of distinct given altitudes H_{Dj}, j=1 to J, which can be selected by a user of the watch, each theoretical measurement distance D_{MTj} and/or each corresponding correction factor F_{Cj} being stored in the watch memory 4 to allow one of the theoretical measurement distances D_{MTj} or one of the correction factors F_{Cj} to be selected, either directly or by selecting an altitude H_{S} for the Kármán limit. It should be noted that this improved implementation is advantageous if an extended range of the altitude H_{S} can be selected for the Kármán line L_{K}, for example between 80 km and 110 km. In this case, the plurality of predetermined altitudes comprises, for example, the value 85 km for a first part of the range of selectable altitudes between 80 km and 90 km, the value 95 km for a second part of the range of selectable altitudes between 90 km and 100 km, and the value 105 km for a third and final part of the range of selectable altitudes between 100 km and 110 km. The plurality of theoretical measurement distances D_{MTj} and/or of respective correction factors F_{Cj} are thus determined beforehand and entered into the watch's memory 4. Each correction factor is thus used to provide a specific reference distance for only one part of the range of selectable altitudes, via a linear approximation based on a theoretical measurement distance for a given altitude located substantially in the middle of the relevant part of said range.

The following is a description of a main embodiment of the watch according to the invention which allows the detection method according to the invention to be implemented.

The watch 2 according to the main embodiment is characterised in that the detection device 6 is arranged to be able to measure periodically, at a measurement frequency F_{M}, the components of a proper acceleration vector of the watch along the three orthogonal axes of the three-dimensional coordinate frame 10 defined by the acceleration sensor 8 and linked to the watch, i.e. to measure a proper acceleration vector by means of the detection device in a coordinate frame of the watch, this proper acceleration vector being equal to a vector sum of the forces to which this watch is subjected, except for the force of gravity, divided by its mass. It should be noted that such a proper acceleration vector can be supplied by an acceleration sensor formed by a microelectromechanical system (MEMS), which is provided for in a preferred alternative embodiment. The detection device 6 is then arranged to be able to calculate, in the electronic unit 12, for each measurement, the norm A_{M}(tₙ) of the proper acceleration vector measured by the acceleration sensor 8 or a corrected norm equal to the norm A_{M}(tₙ) less the norm of the gravitational acceleration A_{E}, tₙ being equal to n·P, where n is a number of measurements made at least since rocket take-off, incremented by one for each successive measurement, and P is the time period defined by the measurement frequency.

The electronic unit 12 is arranged to also be able to calculate, numerically, a double integral over time, at least from rocket take-off, of the proper acceleration A_{P}(t), i.e. of the norm A_{P}(t) of the proper acceleration vector, of the watch and thus also of the rocket (it is assumed that the watch undergoes little or no acceleration from its user other than that generated by the rocket on the watch), respectively of this proper acceleration/norm less the norm of the gravitational acceleration, the proper acceleration A_{P}(t) being determined on the basis of said norms A_{M}(tₙ) of the proper acceleration vectors measured periodically, in order to obtain comparison distances D_{C}(tₘ) for times tₘ, where m is a positive integer, each m corresponding to a said number n. The detection device 6 is then arranged to be able to compare each comparison distance D_{C}(tₘ) with a predetermined reference value, stored in memory, or with a calculated reference value, obtained for a selected altitude H_{S} via a correction factor F_{C}, these values and this correction factor having been defined previously in the context of the general embodiment of the watch, and thus to detect whether the comparison distance D_{C}(tₘ) is greater than this predetermined reference value or than this reference value.

According to an advantageous alternative embodiment, the calculation of the double integral over time, performed in the electronic unit 12, consists in performing a double integral by increments by defining, after each measurement of the proper acceleration, a constant value A_{C}(tₙ) for the norm of the proper acceleration vector over each period P between the times tₙ₋₁ and tₙ, this constant value being determined by the norm A_{M} (tₙ) and/or by the norm A_{M} (tₙ₋₁), to calculate, for each period P, an increase in velocity corresponding to said constant value, or respectively to the constant value less the norm of the gravitational acceleration, in order then to determine an estimated velocity Ve(tₙ)_{E} (tₙ) at the time tₙ, and an elementary distance dₙ on the basis of the constant value A_{C}(tₙ), respectively of this constant value less the norm of the gravitational acceleration and of the estimated velocity V_{E}(tₙ₋₁) at the time tₙ₋₁, and then adding the elementary distance dₙ to the sum of the elementary distances d₁ to dₙ₋₁, obtained at the end of the previous measurement of the proper acceleration, to obtain a comparison distance D_{C}(tₙ) for the time tₙ.

In a particular alternative embodiment, the watch comprises visual and/or vibratory means (a vibrator), and/or optionally audible means, arranged to be able to indicate that the watch has crossed the Kármán line as soon as the detection device has detected that the watch has crossed the Kármán line. If the computing power in the watch is sufficient to calculate the comparison distance D_{C}(tₙ) directly after each measurement of the vector of the watch's proper acceleration at time tₙ, then the crossing of the Kármán line by this watch and thus by the rocket is detected almost in real time.

In a general alternative embodiment, the watch is arranged to be able to record at least a first crossing of the Kármán line by this watch, and preferably each crossing of the Kármán line by the watch. Moreover, it comprises display means 30 arranged to be able to indicate automatically and/or on command whether the Kármán line has been crossed by the watch and, preferably, to indicate a number of times that this event has taken place.

According to a preferred alternative embodiment, the watch is arranged so as to be able to permanently record in the memory 4 a detection of a crossing of the Kármán line by this watch, this recording being made in a protected part 4a of the memory, so that a user of the watch cannot program this protected part.

FIG. 7A to 7D show various messages given by the watch 2, via the digital display 30, during a space flight. By pressing the push-button 16 for a long time, the user installed in the rocket activates the watch's mode for detecting crossing of the Kármán line. The watch then displays ‘KARMAN DET READY’ (FIG. 7A), i.e. it displays that the detection device 6 is ready to detect the crossing of the Kármán line by the watch 2 or respectively by the rocket. The detection device is then able to determine, on the basis of the measurements of the watch's proper acceleration, when the rocket takes off. At this point, the digital display indicates ‘KARMAN ON TK OFF’ (FIG. 7B), i.e. it displays that the detection device is active and that the rocket is taking off. The digital display then indicates the time elapsed since take-off, for example 125 seconds at a given moment by displaying ‘FLIGHT TM 125’ (FIG. 7C). Finally, as soon as the watch has detected the crossing of the Kármán line and thus entry into space itself, the watch displays the message ‘U ARE IN SPACE’ (FIG. 7D, ‘U’ being an abbreviation of ‘YOU’), i.e. it displays that the astronaut has arrived in space with the rocket.

FIGS. 8A and 8B give an example of messages that can be displayed by the watch, particularly outside at least one space mission in which the watch has taken part as an instrument for detecting the crossing of the Kármán line for the astronaut wearing it. By simultaneously pressing the two push-buttons 16 and 17, the watch displays the message ‘WORN IN SPACE’ (FIG. 8A), i.e. that the watch has been worn in space and thus has crossed the Kármán line, on the basis of data stored in its memory, preferably in the protected part 4a formed by a non-volatile memory which can be written to only once (‘OTP’ memory). Preferably, by subsequently pressing the push-button 17, the watch then indicates a number of times that the watch has entered space by the message ‘KARMAN DET NB’ and said number (i.e. 2 in the example given in FIG. 8B).

It has already been described that the watch can be arranged to allow the input of various selectable parameters and/or variables, in particular an altitude for the Kármán limit or an intended tilt angle of the rocket at the time of this event. This data can be entered in particular via a touch screen formed on the watch glass and/or via increasing numbers scrolling across part of the digital display 30 and a push button allowing the scrolling to stop at the predicted value or to be carried out. Alternatively, the hands of the analogue display 34 can be used for this purpose.

It should be noted that the theoretical measurement distance D_{MT}, defining a predetermined reference value, and the corresponding correction factor F_{C}, which makes it possible to determine a calculated reference value, relate to a given type of rocket (also referred to as ‘type of launch vehicle’) as indicated above. In an improved embodiment, the theoretical measurement distances D_{MT} and/or the corresponding correction coefficients can be entered in the watch's memory 4 for several types of rocket. In this case, the watch comprises means for selecting, before a space flight, the type of rocket in question for the planned detection of the crossing of the Kármán line. These selection means can in particular use a list giving the various types of rocket which have been envisaged for the detection application in the watch, this list being viewable by scrolling through the various types of rocket envisaged by means of a control member of the watch and by making a selection using another control member.

Finally, it should be noted that each theoretical measurement distance D_{MT} and each corresponding correction factor F_{C} is relative to a given altitude H_{D}. This given altitude can be either an altitude measured from sea level, i.e. independent of the rocket launch site, or an altitude measured from a specific launch site.

In a sophisticated alternative embodiment, the launch site can also be selected by a user prior to a space flight via the watch's control members and display means. Each launch site thus corresponds to one or more theoretical measurement distances and to one or more corresponding correction factors. In this case, an altitude H_{S} selected by a user will be an altitude from sea level. It is understood that it is advantageous, because it is simpler while remaining accurate, to use altitudes measured from any launch site, i.e. heights measured from the ground at the rocket's point of departure, both for the given altitudes H_{D}, which are used to determine one or more reference values beforehand, and for the altitudes H_{S} selected by a user.

1. A method for detecting the crossing of the Kármán line L_{K}, defined by a given altitude H_{D} or by a selected altitude H_{S}, by a rocket of a given type, during a space flight of this rocket, by means of a portable object worn by a user and carried on board the rocket, this portable object comprising a memory, a time base and a detection device, this detection device being formed by an acceleration sensor, capable of measuring a proper acceleration vector of the portable object in a three-dimensional coordinate frame of this portable object, and by an electronic unit arranged so as to be able to process measurements supplied by the acceleration sensor, the proper acceleration vector of the portable object being equal to the vector sum of the forces to which this portable object is subjected, except for the force of gravity, divided by its mass; the detection method comprising a preliminary phase, which is preliminary to the portable object being placed on board the rocket for said space flight, comprising the following preliminary steps of:
providing a nominal acceleration of motion A_{N}(t) for the rocket of the given type, as a function of time t, from rocket take-off, defining a time zero, at least up to a crossing of said given altitude H_{D}, this nominal acceleration of motion being a scalar value in a unit equal to the gravitational pull of the Earth;
providing a theoretical tilt angle θ_{T}(t) for the rocket of the given type, relative to a horizontal plane and as a function of time t, from rocket take-off until at least one crossing of the given altitude H_{D};
determining or providing a theoretical time of flight T_{K} for the rocket of the given type from rocket take-off to the crossing of the given altitude H_{D};
on the basis of said nominal acceleration of motion and of said theoretical angle of inclination, determining a theoretical proper acceleration A_{PT}(t), as a function of time, for the rocket of the given type, the value of this theoretical proper acceleration being defined, in a unit equal to the Earth's attraction, by the following formula:
$${A}_{PT} ( t ) = \sqrt{1 + 2 \cdot {A}_{N} ( t ) \cdot sin {θ}_{T} ( t ) + {{A}_{N}}^{2} ( t )}$$
calculating, by numerical and/or mathematical means, a theoretical measurement distance D_{MT} defined by a double integration of the theoretical proper acceleration A_{PT}(t), between time zero (t=0) corresponding to rocket take-off and time T_{K} corresponding to the theoretical time of flight, or of this theoretical proper acceleration less the norm of the gravitational acceleration; the theoretical measurement distance D_{MT} divided by the given altitude H_{D} for the Kármán line L_{K} defining, for the rocket of the given type, a correction factor F_{C};
recording the theoretical measurement distance D_{MT} and/or the correction factor F_{C} in the memory of the portable object, this correction factor F_{C} then being, where applicable, multiplied in the electronic unit by the selected altitude H_{S}, before rocket take-off defining a start of said space flight, so as to obtain a reference distance D_{MR};
before rocket take-off, activating the detection device of the portable object on board this rocket;
the detection method then comprising a detection phase comprising the following detection steps of:
periodically measuring, at a measurement frequency F_{M}, the proper acceleration vector of the portable object by means of the detection device, and calculating in the electronic unit, for each measurement, the norm A_{M}(tₙ) of this measured proper acceleration vector, respectively a corrected norm equal to the norm A_{M}(tₙ) less the norm of the gravitational acceleration, tₙ being a time equal to n·P where n is a number of measurements carried out at least since rocket take-off, incremented by one unit with each new measurement, and P is the time period defined by said measurement frequency;
calculating numerically, in the electronic unit, a double integral over time, from rocket take-off, respectively at least from rocket take-off, of the norm of the proper acceleration vector of the portable object, respectively of this norm less the norm of the gravitational acceleration, the norm of the proper acceleration vector being determined on the basis of said norms A_{M}(tₙ) of the proper acceleration vectors measured periodically, in order to obtain comparison distances D_{C}(tₘ) for times tₘ, where m is a positive integer, each m corresponding to one said number n;
comparing each comparison distance D_{C}(tₘ) with the theoretical measurement distance D_{MT} in the case of a given altitude H_{D}, or respectively with the reference distance D_{MR} in the case of a selected altitude H_{S} and, when a comparison distance D_{C}(tₘ) is greater than the theoretical measurement distance D_{MT}, or respectively the reference distance D_{MR}, recording, in the memory of the portable object, a detection, by the detection device, of the crossing of the Kármán line by this portable object.

2. The detection method according to claim 1, wherein the step of calculating, in the electronic unit, the double integral over time of the norm of the proper acceleration vector of the portable object, or respectively of this norm less the norm of the gravitational acceleration consists in performing a double integral by increments by defining, after each measurement of the proper acceleration vector, a constant value A_{C}(tₙ) for the norm of the proper acceleration vector over each period P between the times tₙ₋₁ and tₙ, this constant value being determined by the norm A_{M}(tₙ) and/or by the norm A_{M} (tₙ₋₁), to calculate, for each period P, an increase in velocity corresponding to said constant value, or respectively to the constant value less the norm of the gravitational acceleration, in order then to determine an estimated velocity V_{E}(tₙ) at the time tₙ, and an elementary distance dₙ on the basis of the constant value A_{C}(tₙ), respectively of this constant value less the norm of the gravitational acceleration and of the estimated velocity V_{E}(tₙ₋₁) at the time tₙ₋₁, and then adding the elementary distance dₙ to the sum of the elementary distances d₁ to dₙ₋₁, obtained at the end of the previous measurement of the proper acceleration vector, to obtain a comparison distance D_{C}(tₙ) for the time tₙ.

3. The detection method according to claim 1, wherein said theoretical time of flight T_{K} is determined on the basis of the nominal acceleration of motion and the theoretical tilt angle, in the preliminary phase by the mathematical and/or numerical resolution of the following equation, where H_{D} is said given altitude and the time T is a variable:
$${H}_{D} = {H}_{FT} ( T ) = {\int }_{0}^{T} {V}_{N} ( t ) \cdot sin {θ}_{T} ( t ) \cdot dt , \\ where {V}_{N} ( t ) = {\int }_{0}^{t} {A}_{N} ( t ) \cdot dt$$

4. The detection method according to claim 1, wherein said selected altitude H_{S} is determined as a function of a tilt angle of said rocket which is selected for the crossing of the Kármán line by this rocket and supplied to the portable object prior to a space flight with the rocket.

5. The detection method according to claim 1, wherein the theoretical measurement distance is determined for each given altitude of a plurality of distinct given altitudes H_{Dj}, j=1 to J, which can be selected, each theoretical measurement distance D_{MTj} and/or each corresponding correction factor F_{Cj} being stored in the memory of the portable object to allow one of the theoretical measurement distances D_{MTj} or one of the correction factors F_{Cj} to be selected, either directly or by selecting an altitude for the Kármán limit.

6. The detection method according to claim 1, wherein the acceleration sensor is formed by a microelectromechanical system (MEMS).

7. A portable object (2) capable of being worn by a user comprising a memory (4), a time base and a detection device (6), which is formed by an acceleration sensor (8), capable of measuring an acceleration vector of the portable object in a three-dimensional coordinate frame (10) linked to this portable object, and by an electronic unit (12) arranged so as to be able to process measurements supplied by the acceleration sensor; wherein the detection device (6) is arranged to be able to autonomously detect, during a space flight of a rocket of a given type, a crossing of the Kármán line L_{K} by the portable object on board this rocket, the Kármán line L_{K} being defined by a given altitude H_{D} or an altitude H_{S} that can be selected by the user, either directly or by selecting another spatial variable; wherein a crossing of the Kármán line by the portable object can be detected by the electronic unit (12) on the basis of periodic measurements of the acceleration vector of the portable object, carried out by the acceleration sensor from rocket take-off until the crossing of the Kármán line L_{K}, and either of a predetermined reference value which is stored prior to said take-off in the memory (4), or of a reference value calculated in the electronic unit (12) and determined by a correction factor F_{C}, which is predetermined and stored prior to said take-off in the memory, and an altitude H_{S} selected by the user for the Kármán line prior to said take-off, the predetermined reference value and the correction factor F_{C} being relative to said given altitude H_{D}; and wherein the electronic unit is arranged such that it can calculate the changes to a comparison distance over time on the basis of said periodic measurements of the acceleration vector of the portable object, and compare this comparison distance over time with the predetermined reference value, respectively with said calculated reference value, so as to be able to detect a crossing of the Kármán line by the portable object.

8. The portable object (2) according to claim 7, wherein the detection device (6) is arranged so that the comparison distance is calculated on the basis of the norms of the acceleration vectors measured by the acceleration sensor (8) in said three-dimensional coordinate frame (10), the electronic unit (12) being arranged such that it can calculate these norms.

9. The portable object according to claim 7, wherein said correction factor F_{C} is equal to said predetermined reference value divided by said given altitude H_{D}.

10. The portable object according to claim 7, wherein said predetermined reference value is defined on the basis of at least one theoretical function of a spatial variable relating to said rocket, from rocket take-off to said given altitude H_{D} for the Kármán line L_{K}.

11. The portable object (2) according to claim 7, wherein the memory (4) can contain a plurality of predetermined reference values which are respectively relative to a plurality of given altitudes H_{Dj}, j=1 to J, each of the predetermined reference values being defined on the basis of at least one theoretical function of a spatial variable relative to said rocket, from rocket take-off to the corresponding given altitude, each of the given altitudes being selectable by a user to allow for comparison over time of said comparison distance, calculated when the portable object is detected to have crossed the Kármán line, with the corresponding predetermined reference value.

12. The portable object (2) according to claim 7, wherein the memory (4) can contain a plurality of correction factors relating respectively to a plurality of given altitudes H_{Dj}, j=1 to J, each of the correction factors being selectable as a function of an altitude selected, by a user, for the Kármán line L_{K} to allow for comparison over time of said comparison distance, calculated when the portable object is detected to have crossed the Kármán line, with a reference value determined by the selected correction factor and the selected altitude.

13. The portable object according to claim 12, wherein a plurality of predetermined reference values are respectively defined for the plurality of given altitudes H_{Dj}, each of the predetermined reference values being defined on the basis of at least one theoretical function of a spatial variable relating to said rocket, from rocket take-off to the corresponding given altitude; and wherein said correction factors are respectively equal to said predetermined reference values respectively divided by said given altitudes.

14. The portable object (2) according to claim 7, wherein the acceleration sensor (8) is formed by a microelectromechanical system (MEMS).

15. The portable object (2) according to claim 10, wherein the acceleration sensor (8) is formed by a microelectromechanical system (MEMS); and
wherein said predetermined reference value is further defined on the basis of a nominal acceleration of motion A_{N}(t) for the rocket.

16. The portable object according to claim 12, wherein the acceleration sensor is formed by a microelectromechanical system (MEMS); and
wherein each predetermined reference value is further defined on the basis of a nominal acceleration of motion A_{N}(t) for the rocket.

17. The portable object (2) according to claim 14, wherein the detection device (6) is arranged such that it can periodically measure, at a measurement frequency F_{M}, a proper acceleration vector of the portable object (2) in said three-dimensional coordinate frame (10) by means of the acceleration sensor (8), this proper acceleration vector being equal to the vector sum of the forces to which the portable object is subjected, except for the force of gravity, divided by its mass, and calculating, in the electronic unit (12), for each measurement, the norm A_{M}(tₙ) of this measured proper acceleration vector, respectively a corrected norm equal to the norm A_{M}(tₙ) less the norm of the gravitational acceleration, tₙ being equal to n·P where n is a number of measurements carried out at least since rocket take-off, incremented by one unit with each successive measurement, and P is the time period defined by the measurement frequency; wherein the electronic unit (12) is arranged such that it can numerically calculate a double integral over time, at least from rocket take-off, of the norm of the proper acceleration vector of the portable object, respectively of this norm less the norm of the gravitational acceleration, the norm of the proper acceleration vector being determined on the basis of said norms A_{M}(tₙ) of the proper acceleration vectors measured periodically, in order to obtain comparison distances D_{C}(tₘ) for times tₘ, where m is a positive integer, each m corresponding to one said number n; and wherein the detection device (6) is arranged such that it can compare each comparison distance D_{C}(tₘ) with a said predetermined reference value, stored in memory, or with a said reference value, obtained for a selected altitude H_{S} via a said correction factor, and thus detect whether the comparison distance D_{C}(tₘ) is greater than this predetermined reference value or greater than this reference value.

18. The portable object according to claim 17, wherein the calculation of said double integral over time, performed in the electronic unit, consists in performing a double integral by increments by defining, after each measurement of the proper acceleration vector, a constant value A_{C}(tₙ) for the norm of the proper acceleration vector over each period P between the times tₙ₋₁ and tₙ, this constant value being determined by the norm A_{M}(tₙ) and/or by the norm A_{M}(tₙ₋₁), to calculate, for each period P, an increase in velocity corresponding to said constant value, or respectively to the constant value less the norm of the gravitational acceleration, in order then to determine an estimated velocity V_{E}(tₙ) at the time tₙ, and an elementary distance dₙ on the basis of the constant value A_{C}(tₙ), respectively of this constant value less the norm of the gravitational acceleration and of the estimated velocity V_{E}(tₙ₋₁) at the time tₙ₋₁, and then adding the elementary distance dₙ to the sum of the elementary distances d₁ to dₙ₋₁, obtained at the end of the previous measurement of the proper acceleration vector, to obtain a comparison distance D_{C}(tₙ) for the time tₙ.

19. The portable object according to claim 7, further comprising visual and/or vibratory means, and/or audible means, arranged to be able to indicate that the portable object has crossed the Kármán line as soon as the detection device has detected that the portable object has crossed the Kármán line.

20. The portable object (2) according to claim 7, wherein the portable object is arranged to record at least a first crossing of the Kármán line by this portable object, and preferably each crossing of the Kármán line by the portable object; and wherein the portable object comprises display means (34) arranged to be able to indicate automatically and/or on command whether the Kármán line has been crossed by the portable object and, preferably, to indicate a number of times that this event has taken place.

21. The portable object (2) according to claim 20, wherein the portable object is arranged so as to be able to permanently record in the memory a detection of a crossing of the Kármán line by this portable object, preferably each detection, this recording being made in a protected part (4a) of the memory, so that a user of the portable object cannot program the protected part.

22. The portable object (2) according to claim 7, wherein the portable object is a wristwatch.
